(19) United States
(12) Patent Application Publication
(10) Pub. No.: US 2023/0224875 A1
(43) Pub. Date: Jul. 13, 2023

(54) RAN PROCEDURES FOR SUPPORTING ADAPTIVE PDCCH MONITORING

(71) Applicant: QUALCOMM Incorporated, San Diego, CA (US)

(72) Inventors: Linhai HE, San Diego, CA (US); Wooseok NAM, San Diego, CA (US)

(21) Appl. No.: 18/066,238

(22) Filed: Dec. 14, 2022

Related U.S. Application Data
(60) Provisional application No. 63/266,618, filed on Jan. 10, 2022.

(51) Int. Cl. H04W 72/0446; H04W 72/23; H04L 5/00

(52) U.S. Cl. CPC H04W 72/0446; H04W 72/23; H04L 5/0053

(57) ABSTRACT

A base station may select a configuration for skipping PDCCH monitoring for a predetermined time period. The base station may transmit, to a UE, and the UE may receive, from the base station, the configuration for skipping the PDCCH monitoring. The UE may identify whether a first condition is met during the predetermined time period. The first condition may be associated with a first time window that overlaps at least in part with the predetermined time period. The UE may perform the PDCCH monitoring if the first condition is met during the predetermined time period or skip the PDCCH monitoring if the first condition is not met during the predetermined time period. The PDCCH monitoring may be skipped based on the configuration for skipping the PDCCH monitoring. The PDCCH monitoring may be skipped during a part of the predetermined time period that does not overlap with the first time window.

### CROSS REFERENCE TO RELATED APPLICATION(S)

This application claims the benefit of and priority to U.S. Provisional Application Ser. No. 63/266,618, entitled “RAN PROCEDURES FOR SUPPORTING ADAPTIVE PDCCH MONITORING” and filed on Jan. 10, 2022, which is expressly incorporated by reference herein in its entirety.

### TECHNICAL FIELD

The present disclosure relates generally to communication systems, and more particularly, to physical downlink control channel (PDCCH) monitoring in a wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive, from a base station, a configuration for skipping physical downlink control channel (PDCCH) monitoring for a predetermined time period. The apparatus may identify whether a first condition is met during the predetermined time period. The first condition may be associated with a first time window that overlaps at least in part with the predetermined time period. The apparatus may perform the PDCCH monitoring if the first condition is met during the predetermined time period or may skip the PDCCH monitoring if the first condition is not met during the predetermined time period. The PDCCH monitoring may be skipped based on the configuration for skipping the PDCCH monitoring.

In an aspect of the disclosure, a method, a computer-readable medium, and an apparatus are provided. The apparatus may be a base station. The apparatus may select a configuration for skipping PDCCH monitoring for a predetermined time period. The apparatus may transmit, to a UE, the configuration for skipping the PDCCH monitoring. The PDCCH monitoring may be performed if a first condition is met during the predetermined time period or the PDCCH monitoring may be skipped if the first condition is not met during the predetermined time period. The PDCCH monitoring may be skipped based on the configuration for skipping the PDCCH monitoring. The first condition may be associated with a first time window that overlaps at least in part with the predetermined time period.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating example state transitions associated with adaptive PDCCH monitoring.

FIG. 5 is a diagram illustrating example timelines associated with PDCCH monitoring skipping according to one or more aspects.

FIG. 6 is a diagram of a communication flow of a method of wireless communication.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus.

FIG. 12 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

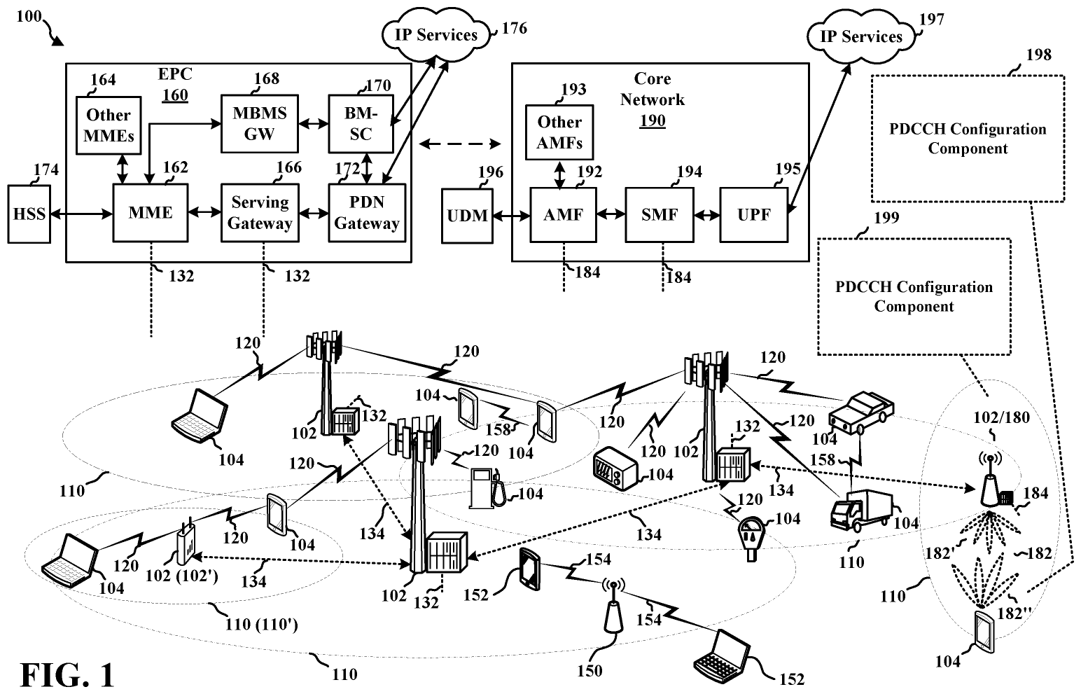

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a PDCCH configuration component 198 that may be configured to receive, from a base station, a configuration for skipping PDCCH monitoring for a predetermined time period. The PDCCH configuration component 198 may be configured to identify whether a first condition is met during the predetermined time period. The first condition may be associated with a first time window that overlaps at least in part with the predetermined time period. The PDCCH configuration component 198 may be configured to perform the PDCCH monitoring if the first condition is met during the predetermined time period or skip the PDCCH monitoring if the first condition is not met during the predetermined time period. The PDCCH monitoring may be skipped based on the configuration for skipping the PDCCH monitoring. In certain aspects, the base station 180 may include a PDCCH configuration component 199 that may be configured to select a configuration for skipping PDCCH monitoring for a predetermined time period. The PDCCH configuration component 199 may be configured to transmit, to a UE, the configuration for skipping the PDCCH monitoring. The PDCCH monitoring may be performed if a first condition is met during the predetermined time period or the PDCCH monitoring may be skipped if the first condition is not met during the predetermined time period. The PDCCH monitoring may be skipped based on the configuration for skipping the PDCCH monitoring. The first condition may be associated with a first time window that overlaps at least in part with the predetermined time period. Although the following description may be focused on 5G NR, the concepts described herein may be applicable to other similar areas, such as LTE, LTE-A, CDMA, GSM, and other wireless technologies.

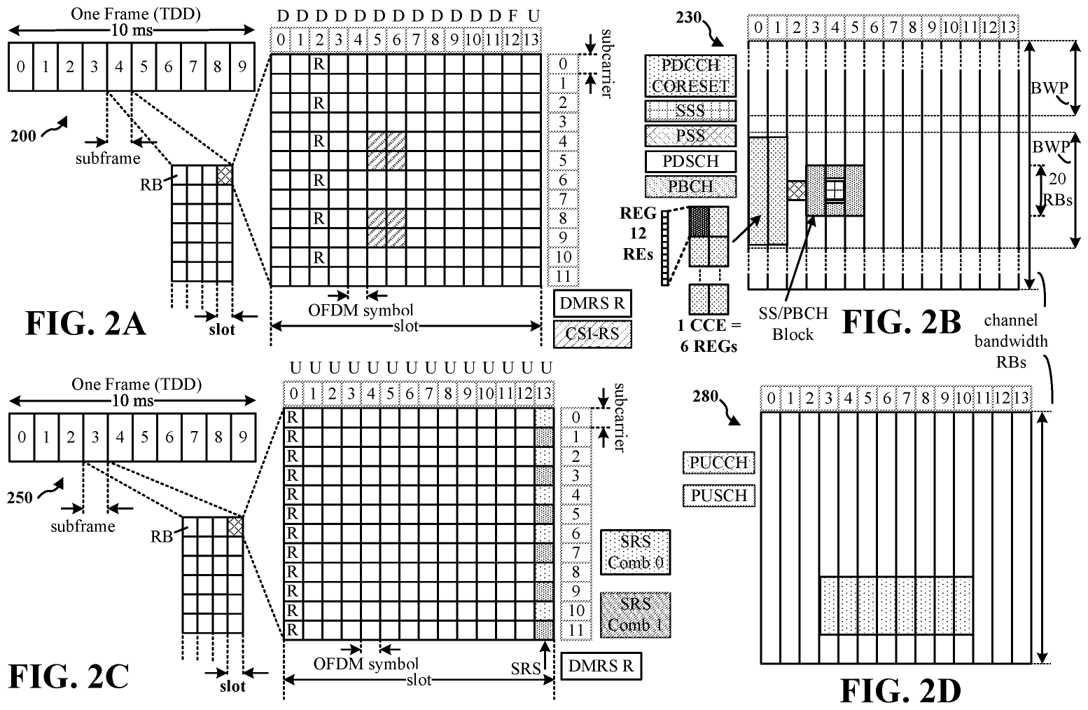

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

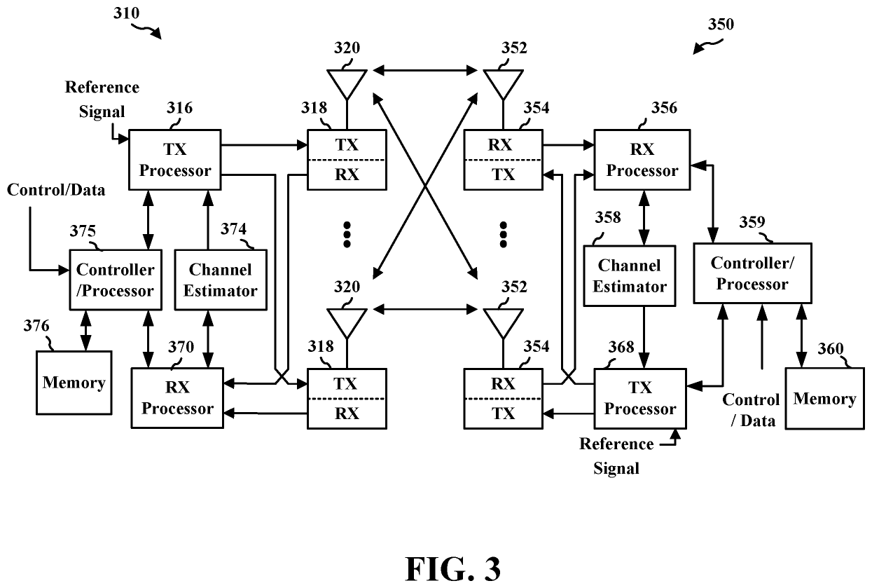

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

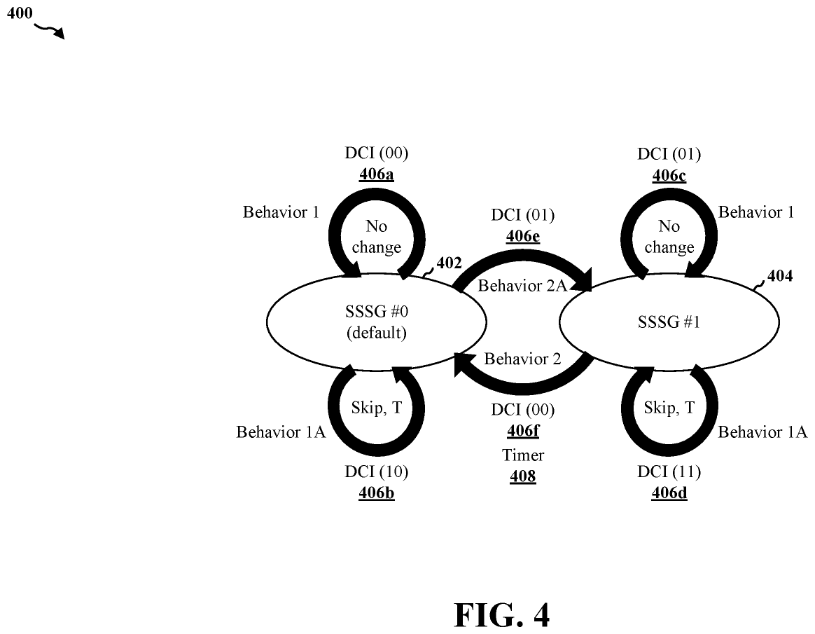

FIG. 4 is a diagram 400 illustrating example state transitions associated with adaptive PDCCH monitoring. Adaptive PDCCH monitoring may include two procedures, namely, search space switching group (SSSG) switching and PDCCH monitoring skipping. For SSSG switching, the network (e.g., a base station) may configure a UE with a number of SSSGs, e.g., via RRC signaling. An SSSG may include a set of search spaces, each of which may be configured for different procedures. The UE may monitor the PDCCH based on a search space, which may be associated with configurations such as the PDCCH monitoring periodicity and so on. For example, a common search space may be used for monitoring for random access responses, and a UE-specific search space may be used for monitoring for DL assignments and/or UL grants, etc. For example, the network may configure the UE with two SSSGs. Then, the network may switch the UE between the two SSSGs, e.g., via DCI messages. The switching between the two SSSGs may be based on traffic dynamics. In some configurations, the two SSSGs may be referred to as a default SSSG (e.g., SSSG #0 402) and a secondary SSSG (e.g., SSSG #1 404). For example, in FIG. 4, when the SSSG #0 402 is active for the UE, the network may switch the SSSG, and may activate the SSSG #1 404 for the UE by transmitting a DCI message 406e to the UE. The UE transitioning from the SSSG #0 402 to the SSSG #1 404 may be referred to as behavior 2A. Similarly, when the SSSG #1 404 is active for the UE, the network may switch the SSSG, and may activate the SSSG #0 402 for the UE by transmitting a DCI message 406f to the UE. The UE transitioning from the SSSG #1 404 to the SSSG #0 402 may be referred to as behavior 2. Further, a timer 408 associated with behavior 2 may be provided. Accordingly, in addition to the DCI-based switching, the UE may also fall back from the SSSG #1 404 to the default SSSG #0 402 when the timer 408 expires.

The two SSSGs may be configured with different PDCCH monitoring periodicities. For example, the default SSSG (e.g., the SSSG #0 402) may be configured with a long PDCCH monitoring periodicity to save UE power, whereas the secondary SSSG (e.g., the SSSG #1 404) may be configured with a shorter PDCCH monitoring periodicity for a higher throughout.

In some configurations, the network may indicate to the UE, e.g., via a DCI message, to skip monitoring for the PDCCH for a predetermined period or duration (e.g., behavior 1A). Hereinafter the predetermined period or duration being used when the UE skips the monitoring of the PDCCH may be referred to as the predetermined time period T. In one configuration, the network may configure the UE with a set of predetermined periods (e.g., 1 ms, 5 ms, 10 ms, etc.) associated with PDCCH monitoring skipping via RRC signaling. Further, the network may activate PDCCH monitoring skipping for the UE by transmitting a DCI message to the UE, where in one example, the DCI message may include a reference to one predetermined period in the set of configured predetermined periods associated with PDCCH monitoring skipping.

For example, when the SSSG #0 402 is active for the UE, the network may indicate to the UE to skip monitoring for the PDCCH for the predetermined time period T by transmitting a DCI message 406b to the UE. Similarly, when the SSSG #1 404 is active for the UE, the network may indicate to the UE to skip monitoring for the PDCCH for the predetermined time period T by transmitting a DCI message 406d to the UE.

Moreover, by transmitting the DCI message 406a or the DCI message 406c when the SSSG #0 402 or the SSSG #1 404 is active for the UE, respectively, the network may indicate to the UE that there is no change associated with PDCCH monitoring (e.g., behavior 1). The above procedures including the transmission of DCI messages may be performed when the UE is in the RRC Connected state. In FIG. 4, the number in the parenthesis after “DCI” may be the codepoint signaled by network in a DCI message. The codepoint may indicate the state to which the UE may switch next. For example, when the SSSG #0 402 is active for the UE and the UE receives a DCI message with a codepoint 01, the UE may activate the SSSG #1 404.

In some examples, for some uplink TX procedures, especially those initiated by the UE, the UE may be expected to monitor the PDCCH for a period of time, in order to receive a confirmation from the network to confirm that the uplink TX is successful. Such uplink TX procedures may include a scheduling request (SR) (for data or for beam failure recovery (BFR)), a random access channel (RACH) procedure transmission (e.g., a message 1 (Msg1), message A (MsgA), or message 3 (Msg3) transmission), or a TX over a configured grant (CG). In particular, for the SR, the UE may be expected to monitor the PDCCH after an SR is sent and pending. Further, for the RACH procedure transmission, the UE may be expected to monitor the PDCCH during a message 2 (Msg2) random access response (RAR) window (a window may be a period of time) or a message B (MsgB) response window after the UE transmits the Msg1 (e.g., for a 4-step RACH procedure) or the MsgA (e.g., for a 2-step RACH procedure), respectively. In addition, the UE may be expected to monitor the PDCCH while a contention resolution timer is still running after the UE transmits the Msg3 in a RACH procedure. Moreover, for the TX over a CG, the UE may start a HARQ retransmission timer after a TX over a CG, and may monitor the PDCCH for possible retransmission requests until the HARQ retransmission timer expires.

In one or more configurations, the UE may ignore PDCCH monitoring skipping based on the PDCCH monitoring skipping indication from the network for the duration in which the UE is expected to monitor the PDCCH in, e.g., one of the above uplink TX procedures, so that the UE may complete the uplink TX procedure. In other words, for the duration in which the UE is expected to monitor the PDCCH in one of the above uplink TX procedures, the UE may monitor the PDCCH as usual irrespective of the fact that the duration may overlap with the predetermined time period T associated with PDCCH monitoring skipping as indicated by the network.

In particular, during the predetermined time period T associated with PDCCH monitoring skipping, the UE may perform PDCCH monitoring as usual if a first condition is met, or may skip the PDCCH monitoring if the first condition is not met, where the first condition is met if 1) an SR transmitted by the UE is pending, 2) a Msg2 RAR window or a MsgB response window is not expired, 3) a contention resolution timer is not expired, or 4) an uplink HARQ retransmission timer is not expired. Therefore, the first condition may be associated with a first time window during which the first condition is met. In other words, the UE may skip the PDCCH monitoring during a part of the predetermined time period T that does not overlap with the first time window.

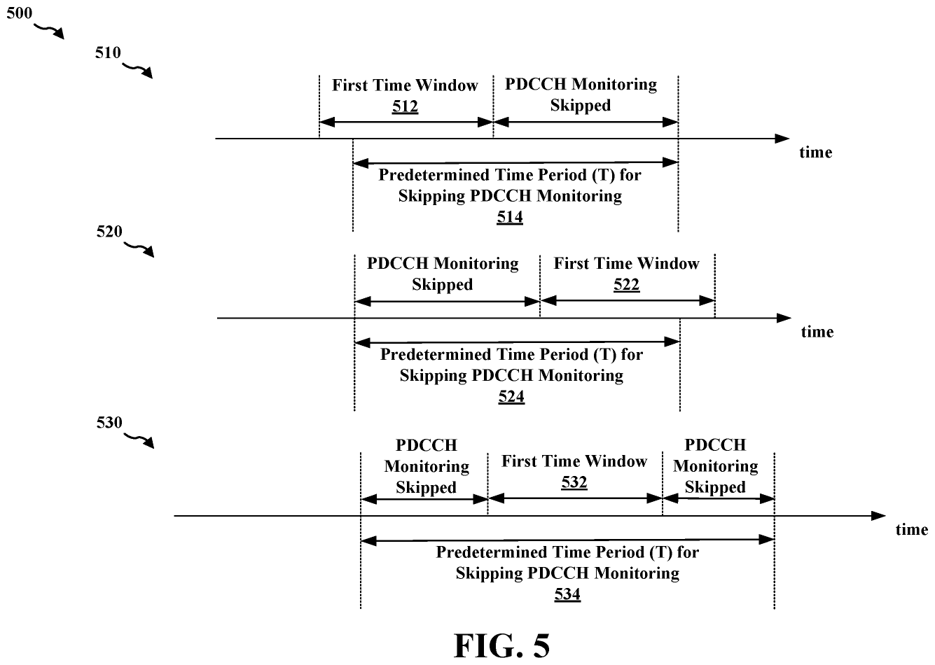

FIG. 5 is a diagram 500 illustrating example timelines associated with PDCCH monitoring skipping according to one or more aspects. In diagram 510, the first time window 512 may start before the predetermined time period T 514 starts, and may end before the predetermined time period T 514 ends. Accordingly, in this example, the UE may skip the PDCCH monitoring during a part of the predetermined time period T 514 that does not overlap with the first time window 512, which may start when the first time window 512 ends, and may end together with the predetermined time period T 514. Further, the UE may perform PDCCH monitoring as usual during the first time window 512.

In diagram 520, the first time window 522 may start after the predetermined time period T 524 starts, and may end after the predetermined time period T 514 ends. Accordingly, in this example, the UE may skip the PDCCH monitoring during a part of the predetermined time period T 524 that does not overlap with the first time window 522, which may start together with the predetermined time period T 524, and may end when the first time window 522 starts. Further, the UE may perform PDCCH monitoring as usual during the first time window 522.

In diagram 530, the first time window 532 may start after the predetermined time period T 534 starts, and may end before the predetermined time period T 514 ends. Accordingly, in this example, the UE may skip the PDCCH monitoring during a part of the predetermined time period T 534 that does not overlap with the first time window 532, which may include two sub-parts: The first sub-part may start together with the predetermined time period T 534, and may end when the first time window 532 starts; the second sub-part may start when the first time window 532 ends, and may end together with the predetermined time period T 534. Further, the UE may perform PDCCH monitoring as usual during the first time window 532.

In another example (not shown), the first time window 532 may start before the predetermined time period T 534 starts, and may end after the predetermined time period T 514 ends. In this example, the UE may not skip the PDCCH monitoring at all, and may perform PDCCH monitoring as usual during the entire first time window.

In one or more configurations, during discontinuous RX (DRX) active periods, a UE may transmit the channel state information (CSI) (also known as the CSI report) and/or the SRS to assist the network (e.g., a base station) in the scheduling of downlink or uplink data transmission. However, if the network has indicated to the UE to skip the PDCCH monitoring for a predetermined time period T, the network may not expect to schedule data transmission for the UE for some time. In such cases, it may be wasteful, in terms of power as well as radio resources, for the UE to transmit CSI reports and/or SRSs as usual during the predetermined time period T, especially if the predetermined time period T is long.

In one or more configurations, the network may configure the UE with a first time period threshold. In one configuration, the UE may refrain from transmitting CSI reports and/or SRSs during the predetermined time period T if the predetermined time period T is greater than the first time period threshold. On the other hand, the UE may transmit the CSI reports and/or SRSs as usual (e.g., as scheduled based on an original periodicity) during the predetermined time period T if the predetermined time period T is less than the first time period threshold.

In another configuration, during the predetermined time period T, the UE may refrain from transmitting a particular CSI or a particular SRS as scheduled if the remaining time period in the predetermined time period T (i.e., a time period from the time the CSI or the SRS is originally scheduled to be transmitted to the end of the predetermined time period T) is greater than the first time period threshold. On the other hand, the UE may transmit the CSI or the SRS as scheduled if the remaining time period in the predetermined time period T is less than the first time period threshold.

In some other configurations, in addition to the first time period threshold, the network may further configure the UE with a first relaxation factor (e.g., an “F_{CSI/SRS}” factor). Therefore, the transmission of the CSI reports and/or SRSs may be relaxed but not skipped altogether during the predetermined time period T if the predetermined time period T is greater than the first time period threshold. In one configuration, the UE may transmit CSI reports and/or SRSs based on a second periodicity during the predetermined time period T if the predetermined time period T is greater than the first time period threshold. The second periodicity may be associated with a longer period (i.e., a lower frequency) than the original periodicity. For example, the period associated with the second periodicity may be equal to the product of the period associated with the original periodicity and the first relaxation factor (e.g., where the first relaxation factor may be greater than 1). On the other hand, the UE may transmit the CSI reports and/or SRSs as usual (e.g., as scheduled based on the original periodicity) during the predetermined time period T if the predetermined time period T is less than the first time period threshold.

In one or more configurations, during a DRX off duration, a UE may monitor for DCI with cyclic redundancy check (CRC) scrambled by power saving-radio network temporary identifier (PS-RNTI) (DCP) messages at DCP occasions in order to determine whether to wake up during the next DRX on duration. For example, if during a DRX off duration, the UE receives a DCP message that indicates there is data for the UE, the UE may wake up at the next DRX on duration in order to receive the data. On the other hand, if during a DRX off duration, the UE does not receive a DCP message, or receives a DCP message that indicates there is no data for the UE, the UE may skip the next DRX on duration (i.e., the UE may not wake up for the next DRX on duration).

When the network (e.g., a base station) schedules a predetermined time period T associated with PDCCH monitoring skipping past a DCP occasion, the network may expect the UE to continue the DRX on/active duration after the end of the predetermined time period T. Therefore, the UE may not monitor for DCP messages during the predetermined time period T when the UE also skips the monitoring of the PDCCH. This may be especially applicable if the predetermined time period T is short (e.g., less than a threshold). On the other hand, if the network configures a predetermined time period T that is long (e.g., greater than a threshold), then the DCP may be useful in bringing the UE out of the sleep state where the UE does not monitor the PDCCH, in case there is incoming data when the UE is not monitoring the PDCCH, so that the UE may resume data reception.

Therefore, in one or more configurations, the network may provide an indication indicative of whether the UE is to monitor for DCP messages when the UE skips the monitoring of the PDCCH during the predetermined time period T. Accordingly, based on the indication from the network, the UE may or may not monitor for DCP messages during the predetermined time period T.

In particular, in one configuration, when configuring the UE with the set of predetermined time periods associated with PDCCH monitoring skipping, the network may include an indication for each predetermined time period in the set of time periods, where the indication may be indicative of whether the UE is to monitor for DCP messages during the predetermined time period T when the respective predetermined time period is used. Therefore, for shorter predetermined time periods in the set of time periods, the indication may be that the UE is not to monitor for DCP messages during the predetermined time period T when the respective predetermined time period is used. On the other hand, for longer predetermined time periods in the set of time periods, the indication may be that the UE is to monitor for DCP messages during the predetermined time period T when the respective predetermined time period is used.

In another configuration, the network-provided indication indicative of whether the UE is to monitor for DCP messages when the UE skips the monitoring of the PDCCH may be a threshold. Therefore, the UE may monitor for DCP messages during the predetermined time period T when the predetermined time period T is greater than the threshold. On the other hand, the UE may not monitor for DCP messages during the predetermined time period T when the predetermined time period T is less than the threshold.

In one or more configurations, a UE may periodically measure configured radio link monitoring (RLM) reference signals or beam failure detection (BFD) reference signals to confirm the communication quality associated with the serving beam for the reception of the PDCCH. However, if the network has indicated to the UE to skip the PDCCH monitoring for a predetermined time period T, the network may not expect to schedule data transmission for the UE for some time. In such cases, it may be wasteful in terms of UE power consumption for the UE to measure the RLM reference signals or the BFD reference signals as usual during the predetermined time period T, especially if the predetermined time period T is long.

In one or more configurations, the network may configure the UE with a second time period threshold. In one configuration, the UE may refrain from measuring the RLM reference signals or the BFD reference signals during the predetermined time period T if the predetermined time period T is greater than the second time period threshold. On the other hand, the UE may measure the RLM reference signals or the BFD reference signals as usual (e.g., as scheduled based on an original measurement periodicity) during the predetermined time period T if the predetermined time period T is less than the second time period threshold.

In some other configurations, in addition to the second time period threshold, the network may further configure the UE with a second relaxation factor (e.g., an “F_{RLM/BFD}” factor). Therefore, the measurement of the RLM reference signals or the BFD reference signals may be relaxed but not stopped altogether during the predetermined time period T if the predetermined time period T is greater than the second time period threshold. In one configuration, the UE may measure the RLM reference signals or the BFD reference signals based on a second measurement periodicity during the predetermined time period T if the predetermined time period T is greater than the second time period threshold. The second measurement periodicity may be associated with a longer period (i.e., a lower frequency) than the original measurement periodicity. For example, the period associated with the second measurement periodicity may be equal to the product of the period associated with the original measurement periodicity and the second relaxation factor (e.g., where the second relaxation factor may be greater than 1). On the other hand, the UE may measure the RLM reference signals or the BFD reference signals as usual (e.g., as scheduled based on the original measurement periodicity) during the predetermined time period T if the predetermined time period T is less than the second time period threshold.

In one or more configurations, a UE may initiate its SSSG (i.e., the UE may select one of the configured SSSGs to activate) when the UE activates a new radio resource. For example, when the UE starts a DRX on duration, when the UE activates a new SCell, or when the UE activates a new BWP (which may also include when the UE activates the first downlink BWP in a newly activated SCell), the UE may select one of the configured SSSGs to activate. In some cases, it may be suitable or desirable for the UE to activate a secondary SSSG directly instead of the default SSSG (the default SSSG may typically be configured for power saving) upon activating the new radio resource, for example, when the network switches the UE to the new radio resource in order to achieve higher throughput instead of power saving.

Accordingly, in one or more configurations, the network may provide the UE with an indication of a first SSSG (which may be different from the default SSSG) to use upon the occurrence of a first event associated with activation of a new radio resource. In different examples, the first event may be the UE starting a DRX on duration, the UE activating a new BWP, or the UE activating a new SCell. Therefore, based on the indication, the UE may use the first SSSG upon the occurrence of the first event. In another configuration, if the network does not provide the UE with any indication of an SSSG, the UE may use the default SSSG when activating a new radio resource.

In one or more configurations, the UE may have better knowledge than the network about the traffic pattern of the UE, the power saving needs of the UE, etc. Therefore, informing the network (e.g., a base station) about the UE-requested parameters associated with adaptive PDCCH monitoring may help the network select more suitable adaptive PDCCH monitoring configurations. In some configurations, the UE may indicate the power saving features (e.g., the number of carriers, DRX parameters, etc.) suitable or desirable for the UE to the network via a UE assistance information (UAI) message.

In one or more configurations, the UE may indicate, to the network, UE-requested parameters (e.g., parameters that are requested by the UE or suitable for the UE) associated with adaptive PDCCH monitoring. In different examples, the UE-requested parameters associated with adaptive PDCCH monitoring may include a UE-requested set of predetermined time periods associated with PDCCH monitoring skipping or a UE-requested length (time duration) of an SSSG switch timer (e.g., the timer 408). In particular, the UE may indicate the UE-requested parameters associated with adaptive PDCCH monitoring to the network via a UAI message transmitted to the network.

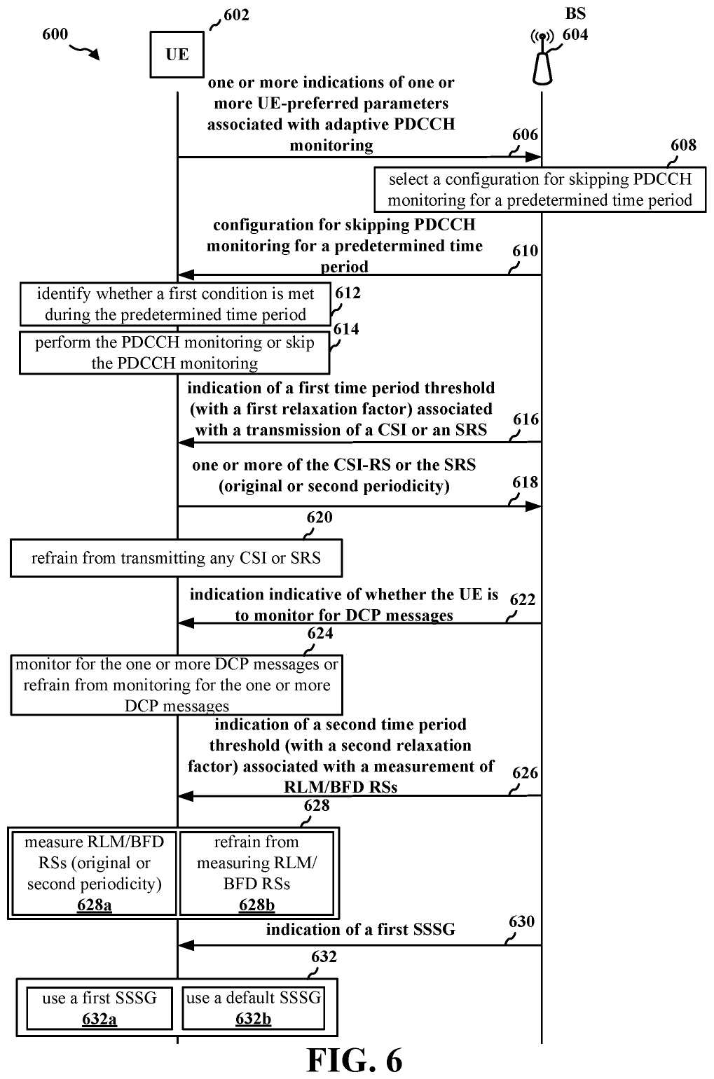

FIG. 6 is a diagram of a communication flow 600 of a method of wireless communication. At 606, a UE 602 may transmit, to a base station 604, one or more indications of one or more UE-requested parameters associated with adaptive PDCCH monitoring.

In one configuration, the UE 602 may transmit the one or more indications of the one or more UE-requested parameters the base station 604 via a UAI message. In one or more configurations, the one or more UE-requested parameters associated with the adaptive PDCCH monitoring may include one or more time durations associated with skipping the PDCCH monitoring or at least one time duration associated with an SSSG switch timer.

At 608, the base station 604 may select a configuration for skipping PDCCH monitoring for a predetermined time period.

At 610, the base station 604 may transmit, to the UE 602, and the UE 602 may receive, from the base station 604, the configuration for skipping PDCCH monitoring for a predetermined time period.

At 612, the UE 602 may identify whether a first condition is met during the predetermined time period.

At 614, the UE 602 may perform the PDCCH monitoring if the first condition is met during the predetermined time period or skip the PDCCH monitoring if the first condition is not met during the predetermined time period. If the PDCCH monitoring is skipped, the PDCCH monitoring may be skipped based on the configuration for skipping the PDCCH monitoring.

In one or more configurations, the first condition may be met if 1) an SR transmitted by the UE 602 is pending, 2) a Msg2 RAR window or a MsgB response window is not expired, 3) a contention resolution timer is not expired, or 4) an uplink HARQ retransmission timer is not expired. In one configuration, if the PDCCH monitoring is skipped, the PDCCH monitoring may be skipped during a part of the predetermined time period that does not overlap with the first time window.

In one configuration, at 616, the base station 604 may transmit, to the UE 602, and the UE 602 may receive, from the base station 604, an indication of a first time period threshold associated with a transmission of a CSI or an SRS.

At 618, the UE 602 may transmit, to the base station 604, and the base station 604 may receive, from the UE 602, during the predetermined time period, one or more of the CSI or the SRS based on an original periodicity if the predetermined time period is less than the first time period threshold.

At 620, the UE 602 may refrain from transmitting any CSI or SRS during the predetermined time period if the predetermined time period is greater than the first time period threshold.

In another configuration, at 616, the base station 604 may transmit, to the UE 602, and the UE 602 may receive, from the base station 604, an indication of a first time period threshold and an indication of a first relaxation factor. The first time period threshold and the first relaxation factor may be associated with a transmission of a CSI or an SRS.

At 618, the UE 602 may transmit, to the base station 604, and the base station 604 may receive, from the UE 602, during the predetermined time period, one or more of the CSI or the SRS based on an original periodicity or a second periodicity. The one or more of the CSI or the SRS may be transmitted and received based on the original periodicity if the predetermined time period is less than the first time period threshold. The one or more of the CSI or the SRS may be transmitted and received based on the second periodicity if the predetermined time period is greater than the first time period threshold. The second periodicity may be associated with a longer period than the original periodicity. The second periodicity may be based on the first relaxation factor.

At 622, the base station 604 may transmit, to the UE 602, and the UE 602 may receive, from the base station 604, a first indication indicative of whether the UE 602 is to monitor for one or more DCP messages at one or more DCP monitoring occasions during the predetermined time period.

At 624, the UE 602 may monitor for the one or more DCP messages or refrain from monitoring for the one or more DCP messages during the predetermined time period based on the first indication.

In one configuration, at 626, the base station 604 may transmit, to the UE 602, and the UE 602 may receive, from the base station 604, an indication of a second time period threshold associated with measuring, at the UE 602, one or more RLM reference signals or one or more BFD reference signals.

At 628a, the UE 602 may measure the one or more RLM reference signals or the one or more BFD reference signals based on an original measurement periodicity during the predetermined time period if the predetermined time period is less than the second time period threshold.

At 628b, the UE 602 may refrain from measuring the one or more RLM reference signals or the one or more BFD reference signals during the predetermined time period if the predetermined time period is greater than the second time period threshold.

In another configuration, at 626, the base station 604 may transmit, to the UE 602, and the UE 602 may receive, from the base station 604, an indication of a second time period threshold and an indication of a second relaxation factor. The second time period threshold and the second relaxation factor may be associated with measuring, at the UE 602, one or more RLM reference signals or one or more BFD reference signals.

At 628a, the UE 602 may measure the one or more RLM reference signals or the one or more BFD reference signals based on an original measurement periodicity or a second measurement periodicity during the predetermined time period. The UE 602 may measure the one or more RLM reference signals or the one or more BFD reference signals based on the original measurement periodicity if the predetermined time period is less than the second time period threshold. The UE 602 may measure the one or more RLM reference signals or the one or more BFD reference signals based on the second measurement periodicity if the predetermined time period is greater than the second time period threshold. The second measurement periodicity may be associated with a longer period than the original measurement periodicity. The second measurement periodicity may be based on the second relaxation factor.

At 630, the base station 604 may transmit, to the UE 602, and the UE 602 may receive, from the base station 604, an indication of a first SSSG associated with a first event.

In one or more configurations, the first event may correspond to at least one of the UE 602 starting a DRX on duration, the UE 602 activating a new BWP, or the UE 602 activating a new SCell.

At 632a, the UE 602 may use the first SSSG at the first event based on the indication of the first SSSG.

At 632b, the UE 602 may use a default SSSG at a first event if an indication of an SSSG is not received from the base station 604.

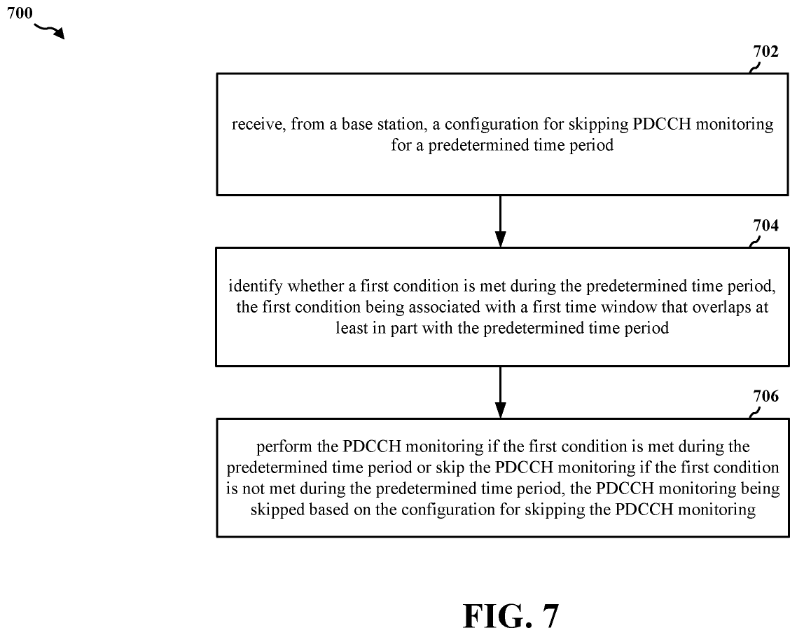

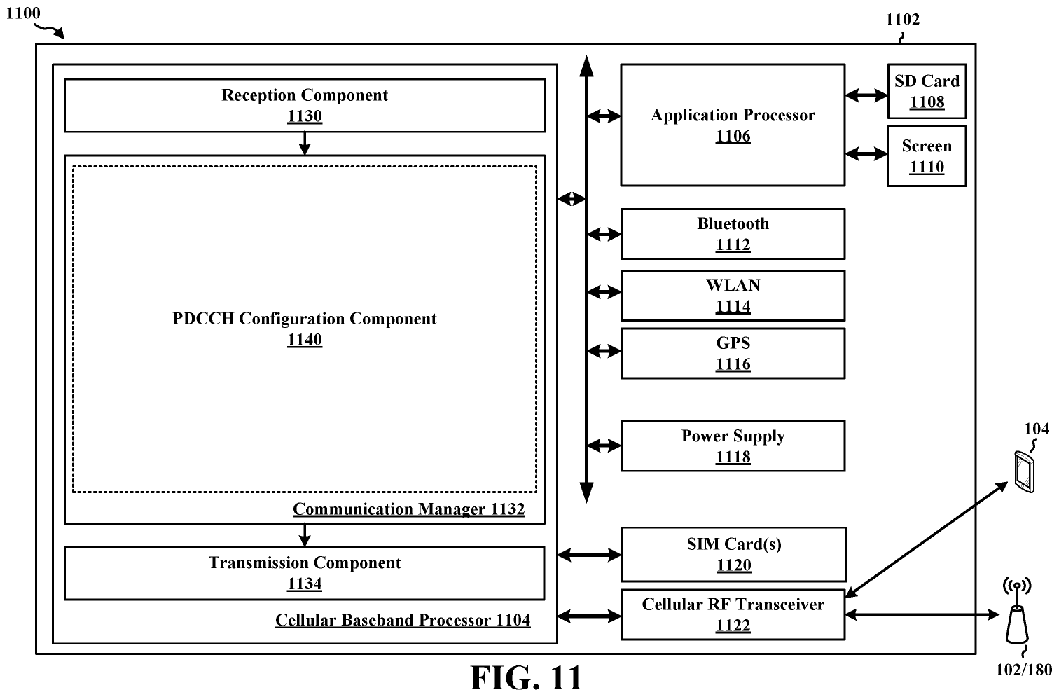

FIG. 7 is a flowchart 700 of a method of wireless communication. The method may be performed by a UE (e.g., the UE 104/350/602; the apparatus 1102). At 702, the UE may receive, from a base station, a configuration for skipping PDCCH monitoring for a predetermined time period. For example, 702 may be performed by the PDCCH configuration component 1140 in FIG. 11. Referring to FIG. 6, at 610, the UE 602 may receive, from a base station 604, a configuration for skipping PDCCH monitoring for a predetermined time period.

At 704, the UE may identify whether a first condition is met during the predetermined time period. The first condition may be associated with a first time window that overlaps at least in part with the predetermined time period. For example, 704 may be performed by the PDCCH configuration component 1140 in FIG. 11. Referring to FIG. 6, at 612, the UE 602 may identify whether a first condition is met during the predetermined time period.

At 706, the UE may perform the PDCCH monitoring if the first condition is met during the predetermined time period or skip the PDCCH monitoring if the first condition is not met during the predetermined time period. The PDCCH monitoring may be skipped based on the configuration for skipping the PDCCH monitoring. For example, 706 may be performed by the PDCCH configuration component 1140 in FIG. 11. Referring to FIG. 6, at 614, the UE 602 may perform the PDCCH monitoring if the first condition is met during the predetermined time period or skip the PDCCH monitoring if the first condition is not met during the predetermined time period.

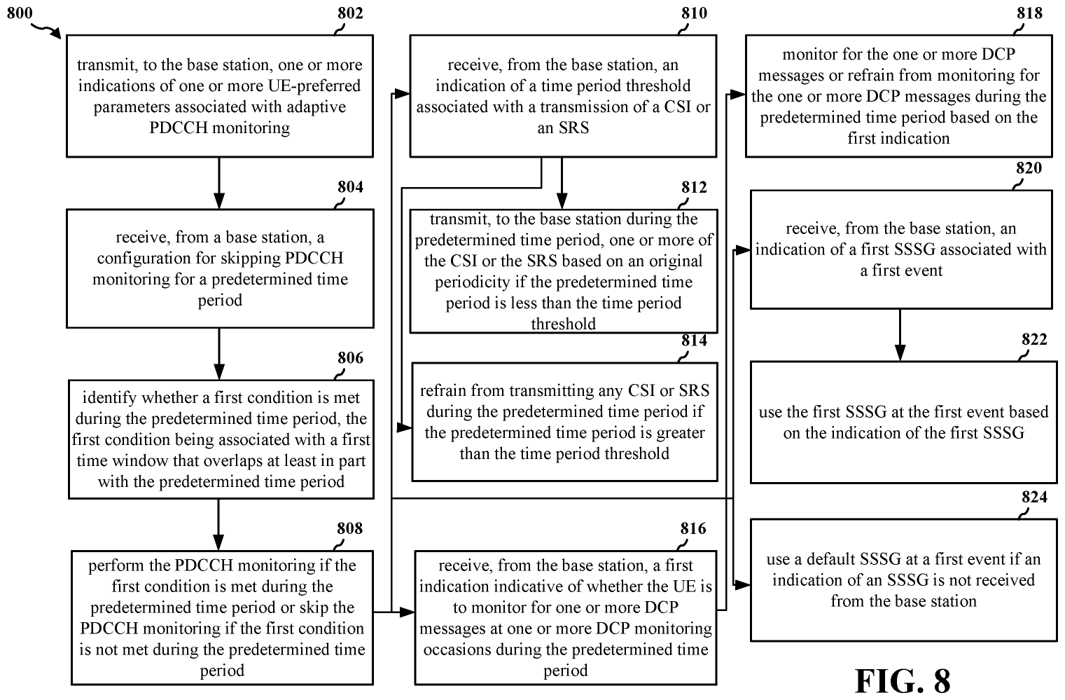

FIG. 8 is a flowchart 800 of a method of wireless communication. The method may be performed by a UE (e.g., the UE 104/350/602; the apparatus 1102). At 804, the UE may receive, from a base station, a configuration for skipping PDCCH monitoring for a predetermined time period. For example, 804 may be performed by the PDCCH configuration component 1140 in FIG. 11. Referring to FIG. 6, at 610, the UE 602 may receive, from a base station 604, a configuration for skipping PDCCH monitoring for a predetermined time period.

At 806, the UE may identify whether a first condition is met during the predetermined time period. The first condition may be associated with a first time window that overlaps at least in part with the predetermined time period. For example, 806 may be performed by the PDCCH configuration component 1140 in FIG. 11. Referring to FIG. 6, at 612, the UE 602 may identify whether a first condition is met during the predetermined time period.

At 808, the UE may perform the PDCCH monitoring if the first condition is met during the predetermined time period or skip the PDCCH monitoring if the first condition is not met during the predetermined time period. The PDCCH monitoring may be skipped based on the configuration for skipping the PDCCH monitoring. For example, 808 may be performed by the PDCCH configuration component 1140 in FIG. 11. Referring to FIG. 6, at 614, the UE 602 may perform the PDCCH monitoring if the first condition is met during the predetermined time period or skip the PDCCH monitoring if the first condition is not met during the predetermined time period.

In one configuration, referring to FIG. 6, the first condition may be met if 1) an SR transmitted by the UE 602 is pending, 2) a Msg2 RAR window or a MsgB response window is not expired, 3) a contention resolution timer is not expired, or 4) an uplink HARQ retransmission timer is not expired.

In one configuration, the PDCCH monitoring may be skipped during a part of the predetermined time period that does not overlap with the first time window.

In one configuration, at 810, the UE may receive, from the base station, an indication of a first time period threshold associated with a transmission of a CSI or an SRS. For example, 810 may be performed by the PDCCH configuration component 1140 in FIG. 11. Referring to FIG. 6, at 616, the UE 602 may receive, from the base station 604, an indication of a first time period threshold associated with a transmission of a CSI or an SRS.

At 812, the UE may transmit, to the base station during the predetermined time period, one or more of the CSI or the SRS based on an original periodicity if the predetermined time period is less than the first time period threshold. For example, 812 may be performed by the PDCCH configuration component 1140 in FIG. 11. Referring to FIG. 6, at 618, the UE 602 may transmit, to the base station 604 during the predetermined time period, one or more of the CSI or the SRS based on an original periodicity if the predetermined time period is less than the first time period threshold.

At 814, the UE may refrain from transmitting any CSI or SRS during the predetermined time period if the predetermined time period is greater than the first time period threshold. For example, 814 may be performed by the PDCCH configuration component 1140 in FIG. 11. Referring to FIG. 6, at 620, the UE 602 may refrain from transmitting any CSI or SRS during the predetermined time period if the predetermined time period is greater than the first time period threshold.

In one configuration, referring to FIG. 6, at 616, the UE 602 may receive, from the base station 604, an indication of a first time period threshold and an indication of a first relaxation factor. The first time period threshold and the first relaxation factor may be associated with a transmission of a CSI or an SRS. At 618, the UE 602 may transmit, to the base station 604, during the predetermined time period, one or more of the CSI or the SRS based on an original periodicity or a second periodicity. The UE 602 may transmit the one or more of the CSI or the SRS based on the original periodicity if the predetermined time period is less than the first time period threshold. The UE 602 may transmit the one or more of the CSI or the SRS based on the second periodicity if the predetermined time period is greater than the first time period threshold. The second periodicity may be associated with a longer period than the original periodicity. The second periodicity may be based on the first relaxation factor.

In one configuration, at 816, the UE may receive, from the base station, a first indication indicative of whether the UE is to monitor for one or more DCP messages at one or more DCP monitoring occasions during the predetermined time period. For example, 816 may be performed by the PDCCH configuration component 1140 in FIG. 11. Referring to FIG. 6, at 622, the UE 602 may receive, from the base station 604, a first indication indicative of whether the UE 602 is to monitor for one or more DCP messages at one or more DCP monitoring occasions during the predetermined time period.

At 818, the UE may monitor for the one or more DCP messages or refrain from monitoring for the one or more DCP messages during the predetermined time period based on the first indication. For example, 818 may be performed by the PDCCH configuration component 1140 in FIG. 11. Referring to FIG. 6, at 624, the UE 602 may monitor for the one or more DCP messages or refrain from monitoring for the one or more DCP messages during the predetermined time period based on the first indication.

In one configuration, referring to FIG. 6, at 626, the UE 602 may receive, from the base station 604, an indication of a second time period threshold associated with measuring, at the UE 602, one or more RLM reference signals or one or more BFD reference signals. At 628a, the UE 602 may measure the one or more RLM reference signals or the one or more BFD reference signals based on an original measurement periodicity during the predetermined time period if the predetermined time period is less than the second time period threshold. At 628b, the UE 602 may refrain from measuring the one or more RLM reference signals or the one or more BFD reference signals during the predetermined time period if the predetermined time period is greater than the second time period threshold.

In one configuration, referring to FIG. 6, at 626, the UE 602 may receive, from the base station 604, an indication of a second time period threshold and an indication of a second relaxation factor. The second time period threshold and the second relaxation factor may be associated with measuring, at the UE 602, one or more RLM reference signals or one or more BFD reference signals. At 628a, the UE 602 may measure the one or more RLM reference signals or the one or more BFD reference signals based on an original measurement periodicity or a second measurement periodicity during the predetermined time period. The UE 602 may measure the one or more RLM reference signals or the one or more BFD reference signals based on the original measurement periodicity if the predetermined time period is less than the second time period threshold. The UE 602 may measure the one or more RLM reference signals or the one or more BFD reference signals based on the second measurement periodicity if the predetermined time period is greater than the second time period threshold. The second measurement periodicity may be associated with a longer period than the original measurement periodicity. The second measurement periodicity may be based on the second relaxation factor.

In one configuration, at 820, the UE may receive, from the base station, an indication of a first SSSG associated with a first event. For example, 820 may be performed by the PDCCH configuration component 1140 in FIG. 11. Referring to FIG. 6, at 630, the UE 602 may receive, from the base station 604, an indication of a first SSSG associated with a first event.

At 822, the UE may use the first SSSG at the first event based on the indication of the first SSSG. For example, 822 may be performed by the PDCCH configuration component 1140 in FIG. 11. Referring to FIG. 6, at 632a, the UE 602 may use the first SSSG at the first event based on the indication of the first SSSG.

In one configuration, referring to FIG. 6, the first event may correspond to at least one of the UE 602 starting a DRX on duration, the UE 602 activating a new BWP, or the UE 602 activating a new SCell.

In one configuration, at 824, the UE may use a default SSSG at a first event if an indication of an SSSG is not received from the base station. For example, 824 may be performed by the PDCCH configuration component 1140 in FIG. 11. Referring to FIG. 6, at 632b, the UE 602 may use a default SSSG at a first event if an indication of an SSSG is not received from the base station 604.

In one configuration, at 802, the UE may transmit, to the base station, one or more indications of one or more UE-requested parameters associated with adaptive PDCCH monitoring. The configuration for skipping the PDCCH monitoring may be based on at least one of the one or more UE-requested parameters. For example, 802 may be performed by the PDCCH configuration component 1140 in FIG. 11. Referring to FIG. 6, at 606, the UE 602 may transmit, to the base station 604, one or more indications of one or more UE-requested parameters associated with adaptive PDCCH monitoring.

In one configuration, referring to FIG. 6, the one or more indications of the one or more UE-requested parameters may be transmitted to the base station 604 via a UAI message.

In one configuration, the one or more UE-requested parameters associated with the adaptive PDCCH monitoring may include one or more time durations associated with skipping the PDCCH monitoring or at least one time duration associated with an SSSG switch timer.

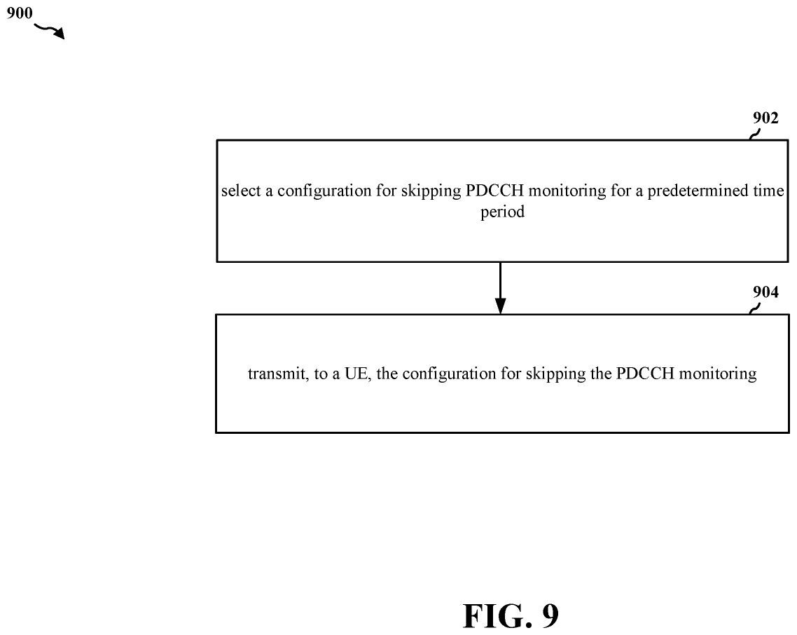

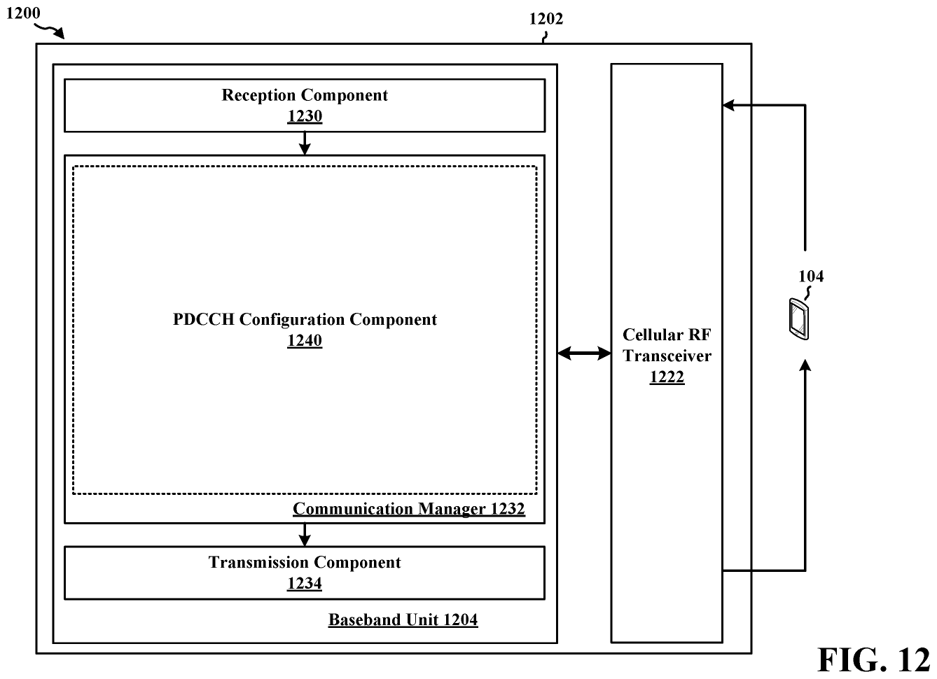

FIG. 9 is a flowchart 900 of a method of wireless communication. The method may be performed by a base station (e.g., the base station 102/180/310/604; the apparatus 1202). At 902, the base station may select a configuration for skipping PDCCH monitoring for a predetermined time period. For example, 902 may be performed by the PDCCH configuration component 1240 in FIG. 12. Referring to FIG. 6, at 608, the base station 604 may select a configuration for skipping PDCCH monitoring for a predetermined time period.

At 904, the base station may transmit, to a UE, the configuration for skipping the PDCCH monitoring. The PDCCH monitoring may be performed if a first condition is met during the predetermined time period or the PDCCH monitoring may be skipped if the first condition is not met during the predetermined time period. The PDCCH monitoring may be skipped based on the configuration for skipping the PDCCH monitoring. The first condition may be associated with a first time window that overlaps at least in part with the predetermined time period. For example, 904 may be performed by the PDCCH configuration component 1240 in FIG. 12. Referring to FIG. 6, at 610, the base station 604 may transmit, to a UE 602, the configuration for skipping the PDCCH monitoring.

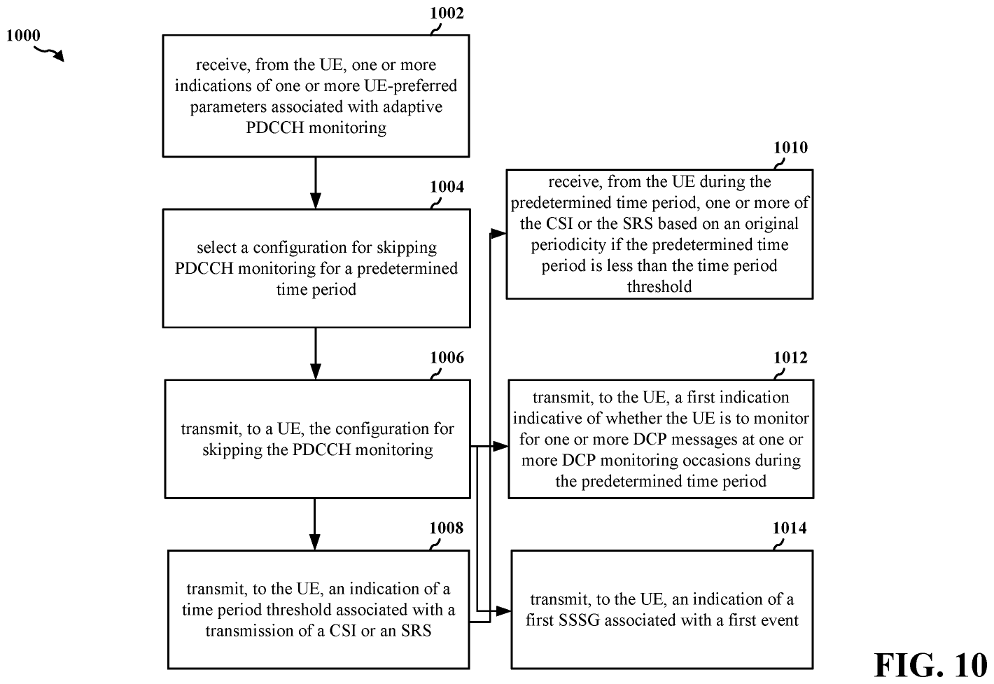

FIG. 10 is a flowchart 1000 of a method of wireless communication. The method may be performed by a base station (e.g., the base station 102/180/310/604; the apparatus 1202). At 1004, the base station may select a configuration for skipping PDCCH monitoring for a predetermined time period. For example, 1004 may be performed by the PDCCH configuration component 1240 in FIG. 12. Referring to FIG. 6, at 608, the base station 604 may select a configuration for skipping PDCCH monitoring for a predetermined time period.

At 1006, the base station may transmit, to a UE, the configuration for skipping the PDCCH monitoring. The PDCCH monitoring may be performed if a first condition is met during the predetermined time period or the PDCCH monitoring may be skipped if the first condition is not met during the predetermined time period. The PDCCH monitoring may be skipped based on the configuration for skipping the PDCCH monitoring. The first condition may be associated with a first time window that overlaps at least in part with the predetermined time period. For example, 1006 may be performed by the PDCCH configuration component 1240 in FIG. 12. Referring to FIG. 6, at 610, the base station 604 may transmit, to a UE 602, the configuration for skipping the PDCCH monitoring.

In one configuration, the first condition may be met if 1) an SR is pending, 2) a Msg2 RAR window or a MsgB response window is not expired, 3) a contention resolution timer is not expired, or 4) an uplink HARQ retransmission timer is not expired.

In one configuration, the PDCCH monitoring may be skipped during a part of the predetermined time period that does not overlap with the first time window.

In one configuration, at 1008, the base station may transmit, to the UE, an indication of a first time period threshold associated with a transmission of a CSI or an SRS. For example, 1008 may be performed by the PDCCH configuration component 1240 in FIG. 12. Referring to FIG. 6, at 616, the base station 604 may transmit, to the UE 602, an indication of a first time period threshold associated with a transmission of a CSI or an SRS.

At 1010, the base station may receive, from the UE during the predetermined time period, one or more of the CSI or the SRS based on an original periodicity if the predetermined time period is less than the first time period threshold. No CSI or SRS may be received during the predetermined time period if the predetermined time period is greater than the first time period threshold. For example, 1010 may be performed by the PDCCH configuration component 1240 in FIG. 12. Referring to FIG. 6, at 618, the base station 604 may receive, from the UE 602 during the predetermined time period, one or more of the CSI or the SRS based on an original periodicity if the predetermined time period is less than the first time period threshold.

In one configuration, referring to FIG. 6, at 616, the base station 604 may transmit, to the UE 602, an indication of a first time period threshold and an indication of a first relaxation factor. The first time period threshold and the first relaxation factor may be associated with a transmission of a CSI or an SRS. At 618, the base station 604 may receive, from the UE 602, during the predetermined time period, one or more of the CSI or the SRS based on an original periodicity or a second periodicity. The one or more of the CSI or the SRS may be received based on the original periodicity if the predetermined time period is less than the first time period threshold. The one or more of the CSI or the SRS may be received based on the second periodicity if the predetermined time period is greater than the first time period threshold. The second periodicity may be associated with a longer period than the original periodicity. The second periodicity may be based on the first relaxation factor.

In one configuration, at 1012, the base station may transmit, to the UE, a first indication indicative of whether the UE is to monitor for one or more DCP messages at one or more DCP monitoring occasions during the predetermined time period. For example, 1012 may be performed by the PDCCH configuration component 1240 in FIG. 12. Referring to FIG. 6, at 622, the base station 604 may transmit, to the UE 602, a first indication indicative of whether the UE 602 is to monitor for one or more DCP messages at one or more DCP monitoring occasions during the predetermined time period.

In one configuration, at 626, the base station 604 may transmit, to the UE 602, an indication of a second time period threshold associated with measuring, at the UE 602, one or more RLM reference signals or one or more BFD reference signals.

In one configuration, at 626, the base station 604 may transmit, to the UE 602, an indication of a second relaxation factor associated with measuring, at the UE 602, one or more RLM reference signals or one or more BFD reference signals.

In one configuration, at 1014, the base station may transmit, to the UE, an indication of a first SSSG associated with a first event. The first SSSG may be used at the first event based on the indication of the first SSSG. For example, 1014 may be performed by the PDCCH configuration component 1240 in FIG. 12. Referring to FIG. 6, at 630, the base station 604 may transmit, to the UE 602, an indication of a first SSSG associated with a first event.

In one configuration, the first event may correspond to at least one of starting of a DRX on duration, activation of a new BWP, or activation of a new SCell.

In one configuration, referring to FIG. 6, a default SSSG may be used at a first event if an indication of an SSSG is not transmitted to the UE 602.

In one configuration, at 1002, the base station may receive, from the UE, one or more indications of one or more UE-requested parameters associated with adaptive PDCCH monitoring. The configuration for skipping the PDCCH monitoring may be selected based on at least one of the one or more UE-requested parameters. For example, 1002 may be performed by the PDCCH configuration component 1240 in FIG. 12. Referring to FIG. 6, at 606, the base station 604 may receive, from the UE 602, one or more indications of one or more UE-requested parameters associated with adaptive PDCCH monitoring.

In one configuration, referring to FIG. 6, the one or more indications of the one or more UE-requested parameters may be received from the UE 602 via a UAI message.

In one configuration, the one or more UE-requested parameters associated with the adaptive PDCCH monitoring may include one or more time durations associated with skipping the PDCCH monitoring or at least one time duration associated with an SSSG switch timer.

FIG. 11 is a diagram 1100 illustrating an example of a hardware implementation for an apparatus 1102. The apparatus 1102 may be a UE, a component of a UE, or may implement UE functionality. In some aspects, the apparatus 1102 may include a cellular baseband processor 1104 (also referred to as a modem) coupled to a cellular RF transceiver 1122. In some aspects, the apparatus 1102 may further include one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, or a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the additional modules of the apparatus 1102.

The communication manager 1132 includes a PDCCH configuration component 1140 that may be configured to transmit, to the base station, one or more indications of one or more UE-requested parameters associated with adaptive PDCCH monitoring, e.g., as described in connection with 802 in FIG. 8. The PDCCH configuration component 1140 may be configured to receive, from a base station, a configuration for skipping PDCCH monitoring for a predetermined time period, e.g., as described in connection with 702 in FIGS. 7 and 804 in FIG. 8. The PDCCH configuration component 1140 may be configured to identify whether a first condition is met during the predetermined time period, e.g., as described in connection with 704 in FIGS. 7 and 806 in FIG. 8. The PDCCH configuration component 1140 may be configured to perform the PDCCH monitoring if the first condition is met during the predetermined time period or skip the PDCCH monitoring if the first condition is not met during the predetermined time period, e.g., as described in connection with 706 in FIGS. 7 and 808 in FIG. 8. The PDCCH configuration component 1140 may be configured to receive, from the base station, an indication of a first time period threshold associated with a transmission of a CSI or an SRS, e.g., as described in connection with 810 in FIG. 8. The PDCCH configuration component 1140 may be configured to transmit, to the base station during the predetermined time period, one or more of the CSI or the SRS if the predetermined time period is less than the first time period threshold, e.g., as described in connection with 812 in FIG. 8. The PDCCH configuration component 1140 may be configured to refrain from transmitting any CSI or SRS during the predetermined time period if the predetermined time period is greater than the first time period threshold, e.g., as described in connection with 814 in FIG. 8. The PDCCH configuration component 1140 may be configured to receive, from the base station, a first indication indicative of whether the UE is to monitor for one or more DCP messages at one or more DCP monitoring occasions during the predetermined time period, e.g., as described in connection with 816 in FIG. 8. The PDCCH configuration component 1140 may be configured to monitor for the one or more DCP messages or refrain from monitoring for the one or more DCP messages during the predetermined time period based on the first indication, e.g., as described in connection with 818 in FIG. 8. The PDCCH configuration component 1140 may be configured to receive, from the base station, an indication of a first SSSG associated with a first event, e.g., as described in connection with 820 in FIG. 8. The PDCCH configuration component 1140 may be configured to use the first SSSG at the first event based on the indication of the first SSSG, e.g., as described in connection with 822 in FIG. 8. The PDCCH configuration component 1140 may be configured to use a default SSSG at a first event if an indication of an SSSG is not received from the base station, e.g., as described in connection with 824 in FIG. 8.

The apparatus may include additional components that perform each of the blocks of the algorithm in the flowcharts of FIGS. 6-8. As such, each block in the flowcharts of FIGS. 6-8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1102 may include a variety of components configured for various functions. In one configuration, the apparatus 1102, and in particular the cellular baseband processor 1104, includes means for receiving, from a base station, a configuration for skipping PDCCH monitoring for a predetermined time period. The apparatus 1102, and in particular the cellular baseband processor 1104, includes means for identifying whether a first condition is met during the predetermined time period. The first condition may be associated with a first time window that overlaps at least in part with the predetermined time period. The apparatus 1102, and in particular the cellular baseband processor 1104, includes means for performing the PDCCH monitoring if the first condition is met during the predetermined time period or skip the PDCCH monitoring if the first condition is not met during the predetermined time period. The PDCCH monitoring may be skipped based on the configuration for skipping the PDCCH monitoring.

In one configuration, the first condition may be met if 1) an SR transmitted by the UE is pending, 2) a Msg2 RAR window or a MsgB response window is not expired, 3) a contention resolution timer is not expired, or 4) an uplink HARQ retransmission timer is not expired. In one configuration, the PDCCH monitoring may be skipped during a part of the predetermined time period that does not overlap with the first time window. In one configuration, the apparatus 1102, and in particular the cellular baseband processor 1104, includes means for receiving, from the base station, an indication of a first time period threshold associated with a transmission of a CSI or an SRS. The apparatus 1102, and in particular the cellular baseband processor 1104, includes means for transmitting, to the base station during the predetermined time period, one or more of the CSI or the SRS based on an original periodicity if the predetermined time period is less than the first time period threshold. The apparatus 1102, and in particular the cellular baseband processor 1104, includes means for refraining from transmitting any CSI or SRS during the predetermined time period if the predetermined time period is greater than the first time period threshold. In one configuration, the apparatus 1102, and in particular the cellular baseband processor 1104, includes means for receiving, from the base station, an indication of a first time period threshold and an indication of a first relaxation factor. The first time period threshold and the first relaxation factor may be associated with a transmission of a CSI or an SRS. The apparatus 1102, and in particular the cellular baseband processor 1104, includes means for transmitting, to the base station during the predetermined time period, one or more of the CSI or the SRS based on an original periodicity or a second periodicity. The one or more of the CSI or the SRS may be transmitted based on the original periodicity if the predetermined time period is less than the first time period threshold. The one or more of the CSI or the SRS may be transmitted based on the second periodicity if the predetermined time period is greater than the first time period threshold. The second periodicity may be associated with a longer period than the original periodicity. The second periodicity may be based on the first relaxation factor. In one configuration, the apparatus 1102, and in particular the cellular baseband processor 1104, includes means for receiving, from the base station, a first indication indicative of whether the UE is to monitor for one or more DCP messages at one or more DCP monitoring occasions during the predetermined time period. The apparatus 1102, and in particular the cellular baseband processor 1104, includes means for monitoring for the one or more DCP messages or refrain from monitoring for the one or more DCP messages during the predetermined time period based on the first indication. In one configuration, the apparatus 1102, and in particular the cellular baseband processor 1104, includes means for receiving, from the base station, an indication of a second time period threshold associated with measuring one or more RLM reference signals or one or more BFD reference signals. The apparatus 1102, and in particular the cellular baseband processor 1104, includes means for measuring the one or more RLM reference signals or the one or more BFD reference signals based on an original measurement periodicity during the predetermined time period if the predetermined time period is less than the second time period threshold. The apparatus 1102, and in particular the cellular baseband processor 1104, includes means for refraining from measuring the one or more RLM reference signals or the one or more BFD reference signals during the predetermined time period if the predetermined time period is greater than the second time period threshold. In one configuration, the apparatus 1102, and in particular the cellular baseband processor 1104, includes means for receiving, from the base station, an indication of a second time period threshold and an indication of a second relaxation factor. The second time period threshold and the second relaxation factor may be associated with measuring one or more RLM reference signals or one or more BFD reference signals. The apparatus 1102, and in particular the cellular baseband processor 1104, includes means for measuring the one or more RLM reference signals or the one or more BFD reference signals based on an original measurement periodicity or a second measurement periodicity during the predetermined time period. The one or more RLM reference signals or the one or more BFD reference signals may be measured based on the original measurement periodicity if the predetermined time period is less than the second time period threshold. The one or more RLM reference signals or the one or more BFD reference signals may be measured based on the second measurement periodicity if the predetermined time period is greater than the second time period threshold. The second measurement periodicity may be associated with a longer period than the original measurement periodicity. The second measurement periodicity may be based on the second relaxation factor. In one configuration, the apparatus 1102, and in particular the cellular baseband processor 1104, includes means for receiving, from the base station, an indication of a first SSSG associated with a first event. The apparatus 1102, and in particular the cellular baseband processor 1104, includes means for using the first SSSG at the first event based on the indication of the first SSSG. In one configuration, the first event may correspond to at least one of the UE starting a DRX on duration, the UE activating a new BWP, or the UE activating a new SCell. In one configuration, the apparatus 1102, and in particular the cellular baseband processor 1104, includes means for using a default SSSG at a first event if an indication of an SSSG is not received from the base station. In one configuration, the apparatus 1102, and in particular the cellular baseband processor 1104, includes means for transmitting, to the base station, one or more indications of one or more UE-requested parameters associated with adaptive PDCCH monitoring. The configuration for skipping the PDCCH monitoring may be based on at least one of the one or more UE-requested parameters. In one configuration, the one or more indications of the one or more UE-requested parameters may be transmitted to the base station via a UAI message. In one configuration, the one or more UE-requested parameters associated with the adaptive PDCCH monitoring may include one or more time durations associated with skipping the PDCCH monitoring or at least one time duration associated with an SSSG switch timer.

The means may be one or more of the components of the apparatus 1102 configured to perform the functions recited by the means. As described supra, the apparatus 1102 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 12 is a diagram 1200 illustrating an example of a hardware implementation for an apparatus 1202. The apparatus 1202 may be a base station, a component of a base station, or may implement base station functionality. In some aspects, the apparatus 1202 may include a baseband unit 1204. The baseband unit 1204 may communicate through a cellular RF transceiver 1222 with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the base station 310 and may include the memory 376 and/or at least one of the TX processor 316, the RX processor 370, and the controller/processor 375.

The communication manager 1232 includes a PDCCH configuration component 1240 that may be configured to receive, from the UE, one or more indications of one or more UE-requested parameters associated with adaptive PDCCH monitoring, e.g., as described in connection with 1002 in FIG. 10. The PDCCH configuration component 1240 may be configured to select a configuration for skipping PDCCH monitoring for a predetermined time period, e.g., as described in connection with 902 in FIGS. 9 and 1004 in FIG. 10. The PDCCH configuration component 1240 may be configured to transmit, to a UE, the configuration for skipping the PDCCH monitoring, e.g., as described in connection with 904 in FIGS. 9 and 1006 in FIG. 10. The PDCCH configuration component 1240 may be configured to transmit, to the UE, an indication of a first time period threshold associated with a transmission of a CSI or an SRS, e.g., as described in connection with 1008 in FIG. 10. The PDCCH configuration component 1240 may be configured to receive, from the UE during the predetermined time period, one or more of the CSI or the SRS if the predetermined time period is less than the first time period threshold, e.g., as described in connection with 1010 in FIG. 10. The PDCCH configuration component 1240 may be configured to transmit, to the UE, a first indication indicative of whether the UE is to monitor for one or more DCP messages at one or more DCP monitoring occasions during the predetermined time period, e.g., as described in connection with 1012 in FIG. 10. The PDCCH configuration component 1240 may be configured to transmit, to the UE, an indication of a first SSSG associated with a first event, e.g., as described in connection with 1014 in FIG. 10.

The apparatus may include additional components that perform each of the blocks of the algorithm in the flowcharts of FIGS. 6, 9, and 10. As such, each block in the flowcharts of FIGS. 6, 9, and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the baseband unit 1204, includes means for selecting a configuration for skipping PDCCH monitoring for a predetermined time period. The apparatus 1202, and in particular the baseband unit 1204, includes means for transmitting, to a UE, the configuration for skipping the PDCCH monitoring. The PDCCH monitoring may be performed if a first condition is met during the predetermined time period or the PDCCH monitoring may be skipped if the first condition is not met during the predetermined time period. The PDCCH monitoring may be skipped based on the configuration for skipping the PDCCH monitoring. The first condition may be associated with a first time window that overlaps at least in part with the predetermined time period.

In one configuration, the first condition may be met if 1) an SR is pending, 2) a Msg2 RAR window or a MsgB response window is not expired, 3) a contention resolution timer is not expired, or 4) an uplink HARQ retransmission timer is not expired. In one configuration, the PDCCH monitoring may be skipped during a part of the predetermined time period that does not overlap with the first time window. In one configuration, the apparatus 1202, and in particular the baseband unit 1204, includes means for transmitting, to the UE, an indication of a first time period threshold associated with a transmission of a CSI or an SRS. The apparatus 1202, and in particular the baseband unit 1204, includes means for receiving, from the UE during the predetermined time period, one or more of the CSI or the SRS based on an original periodicity if the predetermined time period is less than the first time period threshold. No CSI or SRS may be received during the predetermined time period if the predetermined time period is greater than the first time period threshold. In one configuration, the apparatus 1202, and in particular the baseband unit 1204, includes means for transmitting, to the UE, an indication of a first time period threshold and an indication of a first relaxation factor. The first time period threshold and the first relaxation factor may be associated with a transmission of a CSI or an SRS. The apparatus 1202, and in particular the baseband unit 1204, includes means for receiving, from the UE during the predetermined time period, one or more of the CSI or the SRS based on an original periodicity or a second periodicity. The one or more of the CSI or the SRS may be received based on the original periodicity if the predetermined time period is less than the first time period threshold. The one or more of the CSI or the SRS may be received based on the second periodicity if the predetermined time period is greater than the first time period threshold. The second periodicity may be associated with a longer period than the original periodicity. The second periodicity may be based on the first relaxation factor. In one configuration, the apparatus 1202, and in particular the baseband unit 1204, includes means for transmitting, to the UE, a first indication indicative of whether the UE is to monitor for one or more DCP messages at one or more DCP monitoring occasions during the predetermined time period. In one configuration, the apparatus 1202, and in particular the baseband unit 1204, includes means for transmitting, to the UE, an indication of a second time period threshold associated with a measurement of one or more RLM reference signals or one or more BFD reference signals. In one configuration, the apparatus 1202, and in particular the baseband unit 1204, includes means for transmitting, to the UE, an indication of a second relaxation factor associated with the measurement of the one or more radio link monitoring RLM reference signals or the one or more BFD reference signals. In one configuration, the apparatus 1202, and in particular the baseband unit 1204, includes means for transmitting, to the UE, an indication of a first SSSG associated with a first event. The first SSSG may be used at the first event based on the indication of the first SSSG. In one configuration, the first event may correspond to at least one of starting of a DRX on duration, activation of a new BWP, or activation of a new SCell. In one configuration, a default SSSG may be used at a first event if an indication of an SSSG is not transmitted to the UE. In one configuration, the apparatus 1202, and in particular the baseband unit 1204, includes means for receiving, from the UE, one or more indications of one or more UE-requested parameters associated with adaptive PDCCH monitoring. The configuration for skipping the PDCCH monitoring may be selected based on at least one of the one or more UE-requested parameters. In one configuration, the one or more indications of the one or more UE-requested parameters may be received from the UE via a UAI message. In one configuration, the one or more UE-requested parameters associated with the adaptive PDCCH monitoring may include one or more time durations associated with skipping the PDCCH monitoring or at least one time duration associated with an SSSG switch timer.

The means may be one or more of the components of the apparatus 1202 configured to perform the functions recited by the means. As described supra, the apparatus 1202 may include the TX Processor 316, the RX Processor 370, and the controller/processor 375. As such, in one configuration, the means may be the TX Processor 316, the RX Processor 370, and the controller/processor 375 configured to perform the functions recited by the means.

Referring back to FIGS. 4-12, a base station may select a configuration for skipping PDCCH monitoring for a predetermined time period. The base station may transmit, to a UE, and the UE may receive, from the base station, the configuration for skipping the PDCCH monitoring. The UE may identify whether a first condition is met during the predetermined time period. The first condition may be associated with a first time window that overlaps at least in part with the predetermined time period. The UE may perform the PDCCH monitoring if the first condition is met during the predetermined time period or skip the PDCCH monitoring if the first condition is not met during the predetermined time period. The PDCCH monitoring may be skipped based on the configuration for skipping the PDCCH monitoring. Accordingly, the network configured period for skipping the PDCCH monitoring may not interfere with the UE completing certain uplink TX procedures, where the UE may be expected to monitor the PDCCH after the TX in order to receive the confirmation from the network.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to receive, from a base station, a configuration for skipping PDCCH monitoring for a predetermined time period; identify whether a first condition is met during the predetermined time period, the first condition being associated with a first time window that overlaps at least in part with the predetermined time period; and perform the PDCCH monitoring if the first condition is met during the predetermined time period or skip the PDCCH monitoring if the first condition is not met during the predetermined time period, the PDCCH monitoring being skipped based on the configuration for skipping the PDCCH monitoring.

Aspect 2 is the apparatus of aspect 1, where the first condition is met if 1) an SR transmitted by the UE is pending, 2) a Msg2 RAR window or a MsgB response window is not expired, 3) a contention resolution timer is not expired, or 4) an uplink HARQ retransmission timer is not expired.

Aspect 3 is the apparatus of any of aspects 1 and 2, where the PDCCH monitoring is skipped during a part of the predetermined time period that does not overlap with the first time window.

Aspect 4 is the apparatus of any of aspects 1 to 3, the at least one processor being further configured to: receive, from the base station, an indication of a first time period threshold associated with a transmission of a CSI or an SRS; transmit, to the base station during the predetermined time period, one or more of the CSI or the SRS based on an original periodicity if the predetermined time period is less than the first time period threshold; and refrain from transmitting any CSI or SRS during the predetermined time period if the predetermined time period is greater than the first time period threshold.

Aspect 5 is the apparatus of any of aspects 1 to 3, the at least one processor being further configured to: receive, from the base station, an indication of a first time period threshold and an indication of a first relaxation factor, the first time period threshold and the first relaxation factor being associated with a transmission of a CSI or an SRS; and transmit, to the base station during the predetermined time period, one or more of the CSI or the SRS based on an original periodicity or a second periodicity, where the one or more of the CSI or the SRS is transmitted based on the original periodicity if the predetermined time period is less than the first time period threshold, the one or more of the CSI or the SRS is transmitted based on the second periodicity if the predetermined time period is greater than the first time period threshold, the second periodicity is associated with a longer period than the original periodicity, and the second periodicity is based on the first relaxation factor.

Aspect 6 is the apparatus of any of aspects 1 to 5, the at least one processor being further configured to: receive, from the base station, a first indication indicative of whether the UE is to monitor for one or more DCP messages at one or more DCP monitoring occasions during the predetermined time period; and monitor for the one or more DCP messages or refrain from monitoring for the one or more DCP messages during the predetermined time period based on the first indication.

Aspect 7 is the apparatus of any of aspects 1 to 6, the at least one processor being further configured to: receive, from the base station, an indication of a second time period threshold associated with measuring one or more RLM reference signals or one or more BFD reference signals; measure the one or more RLM reference signals or the one or more BFD reference signals based on an original measurement periodicity during the predetermined time period if the predetermined time period is less than the second time period threshold; and refrain from measuring the one or more RLM reference signals or the one or more BFD reference signals during the predetermined time period if the predetermined time period is greater than the second time period threshold.

Aspect 8 is the apparatus of any of aspects 1 to 6, the at least one processor being further configured to: receive, from the base station, an indication of a second time period threshold and an indication of a second relaxation factor, the second time period threshold and the second relaxation factor being associated with measuring one or more RLM reference signals or one or more BFD reference signals; and measure the one or more RLM reference signals or the one or more BFD reference signals based on an original measurement periodicity or a second measurement periodicity during the predetermined time period, where the one or more RLM reference signals or the one or more BFD reference signals are measured based on the original measurement periodicity if the predetermined time period is less than the second time period threshold, the one or more RLM reference signals or the one or more BFD reference signals are measured based on the second measurement periodicity if the predetermined time period is greater than the second time period threshold, the second measurement periodicity is associated with a longer period than the original measurement periodicity, and the second measurement periodicity is based on the second relaxation factor.

Aspect 9 is the apparatus of any of aspects 1 to 8, the at least one processor being further configured to: receive, from the base station, an indication of a first SSSG associated with a first event; and use the first SSSG at the first event based on the indication of the first SSSG.

Aspect 10 is the apparatus of aspect 9, where the first event corresponds to at least one of the UE starting a DRX on duration, the UE activating a new BWP, or the UE activating a new SCell.

Aspect 11 is the apparatus of any of aspects 1 to 8 and 10, the at least one processor being further configured to: use a default SSSG at a first event if an indication of an SSSG is not received from the base station.

Aspect 12 is the apparatus of any of aspects 1 to 11, the at least one processor being further configured to: transmit, to the base station, one or more indications of one or more UE-requested parameters associated with adaptive PDCCH monitoring, where the configuration for skipping the PDCCH monitoring is based on at least one of the one or more UE-requested parameters.

Aspect 13 is the apparatus of aspect 12, where the one or more indications of the one or more UE-requested parameters are transmitted to the base station via a UAI message.

Aspect 14 is the apparatus of any of aspects 12 and 13, where the one or more UE-requested parameters associated with the adaptive PDCCH monitoring include one or more time durations associated with skipping the PDCCH monitoring or at least one time duration associated with an SSSG switch timer.

Aspect 15 is the apparatus of any of aspects 1 to 14, further including a transceiver coupled to the at least one processor.

Aspect 16 is an apparatus for wireless communication at a base station including at least one processor coupled to a memory and configured to select a configuration for skipping PDCCH monitoring for a predetermined time period; and transmit, to a UE, the configuration for skipping the PDCCH monitoring, where the PDCCH monitoring is performed if a first condition is met during the predetermined time period or the PDCCH monitoring is skipped if the first condition is not met during the predetermined time period, the PDCCH monitoring being skipped based on the configuration for skipping the PDCCH monitoring, the first condition being associated with a first time window that overlaps at least in part with the predetermined time period.

Aspect 17 is the apparatus of aspect 16, where the first condition is met if 1) an SR is pending, 2) a Msg2 RAR window or a MsgB response window is not expired, 3) a contention resolution timer is not expired, or 4) an uplink HARQ retransmission timer is not expired.

Aspect 18 is the apparatus of any of aspects 16 and 17, where the PDCCH monitoring is skipped during a part of the predetermined time period that does not overlap with the first time window.

Aspect 19 is the apparatus of any of aspects 16 to 18, the at least one processor being further configured to: transmit, to the UE, an indication of a first time period threshold associated with a transmission of a CSI or an SRS; receive, from the UE during the predetermined time period, one or more of the CSI or the SRS based on an original periodicity if the predetermined time period is less than the first time period threshold, where no CSI or SRS is received during the predetermined time period if the predetermined time period is greater than the first time period threshold.

Aspect 20 is the apparatus of any of aspects 16 to 18, the at least one processor being further configured to: transmit, to the UE, an indication of a first time period threshold and an indication of a first relaxation factor, the first time period threshold and the first relaxation factor being associated with a transmission of a CSI or an SRS; and receive, from the UE during the predetermined time period, one or more of the CSI or the SRS based on an original periodicity or a second periodicity, wherein the one or more of the CSI or the SRS is received based on the original periodicity if the predetermined time period is less than the first time period threshold, the one or more of the CSI or the SRS is received based on the second periodicity if the predetermined time period is greater than the first time period threshold, the second periodicity is associated with a longer period than the original periodicity, and the second periodicity is based on the first relaxation factor.

Aspect 21 is the apparatus of any of aspects 16 to 20, the at least one processor being further configured to: transmit, to the UE, a first indication indicative of whether the UE is to monitor for one or more DCP messages at one or more DCP monitoring occasions during the predetermined time period.

Aspect 22 is the apparatus of any of aspects 16 to 21, the at least one processor being further configured to: transmit, to the UE, an indication of a second time period threshold associated with a measurement of one or more RLM reference signals or one or more BFD reference signals.

Aspect 23 is the apparatus of aspect 22, the at least one processor being further configured to: transmit, to the UE, an indication of a second relaxation factor associated with the measurement of the one or more radio link monitoring RLM reference signals or the one or more BFD reference signals.

Aspect 24 is the apparatus of any of aspects 16 to 23, the at least one processor being further configured to: transmit, to the UE, an indication of a first SSSG associated with a first event, where the first SSSG is used at the first event based on the indication of the first SSSG.

Aspect 25 is the apparatus of aspect 24, where the first event corresponds to at least one of starting of a DRX on duration, activation of a new BWP, or activation of a new SCell.

Aspect 26 is the apparatus of any of aspects 16 to 23 and 25, where a default SSSG is used at a first event if an indication of an SSSG is not transmitted to the UE.

Aspect 27 is the apparatus of any of aspects 16 to 26, the at least one processor being further configured to: receive, from the UE, one or more indications of one or more UE-requested parameters associated with adaptive PDCCH monitoring, where the configuration for skipping the PDCCH monitoring is selected based on at least one of the one or more UE-requested parameters.

Aspect 28 is the apparatus of aspect 27, where the one or more indications of the one or more UE-requested parameters are received from the UE via a UAI message.

Aspect 29 is the apparatus of any of aspects 27 and 28, where the one or more UE-requested parameters associated with the adaptive PDCCH monitoring include one or more time durations associated with skipping the PDCCH monitoring or at least one time duration associated with an SSSG switch timer.

Aspect 30 is the apparatus of any of aspects 16 to 29, further including a transceiver coupled to the at least one processor.

Aspect 31 is a method of wireless communication for implementing any of aspects 1 to 30.

Aspect 32 is an apparatus for wireless communication including means for implementing any of aspects 1 to 30.

Aspect 33 is a computer-readable medium storing computer executable code, where the code when executed by a processor causes the processor to implement any of aspects 1 to 30.

What is claimed is:

1. An apparatus for wireless communication at a user equipment (UE), comprising:
a memory; and
at least one processor coupled to the memory and configured to:
receive, from a base station, a configuration for skipping physical downlink control channel (PDCCH) monitoring for a predetermined time period;
identify whether a first condition is met during the predetermined time period, the first condition being associated with a first time window that overlaps at least in part with the predetermined time period; and
perform the PDCCH monitoring if the first condition is met during the predetermined time period or skip the PDCCH monitoring if the first condition is not met during the predetermined time period, the PDCCH monitoring being skipped based on the configuration for skipping the PDCCH monitoring.

2. The apparatus of claim 1, wherein the first condition is met if 1) a scheduling request (SR) transmitted by the UE is pending, 2) a Message 2 (Msg2) random access response (RAR) window or a Message B (MsgB) response window is not expired, 3) a contention resolution timer is not expired, or 4) an uplink hybrid automatic repeat request (HARQ) retransmission timer is not expired.

3. The apparatus of claim 1, wherein the PDCCH monitoring is skipped during a part of the predetermined time period that does not overlap with the first time window.

4. The apparatus of claim 3, the at least one processor being further configured to:
receive, from the base station, an indication of a time period threshold associated with a transmission of a channel state information (CSI) or a sounding reference signal (SRS);
transmit, to the base station during the predetermined time period, one or more of the CSI or the SRS based on an original periodicity if the predetermined time period is less than the time period threshold; and
refrain from transmitting any CSI or SRS during the predetermined time period if the predetermined time period is greater than the time period threshold.

5. The apparatus of claim 3, the at least one processor being further configured to:
receive, from the base station, an indication of a first time period threshold and an indication of a first relaxation factor, the first time period threshold and the first relaxation factor being associated with a transmission of a channel state information (CSI) or a sounding reference signal (SRS); and
transmit, to the base station during the predetermined time period, one or more of the CSI or the SRS based on an original periodicity or a second periodicity, wherein the one or more of the CSI or the SRS is transmitted based on the original periodicity if the predetermined time period is less than the first time period threshold, the one or more of the CSI or the SRS is transmitted based on the second periodicity if the predetermined time period is greater than the first time period threshold, the second periodicity is associated with a longer period than the original periodicity, and the second periodicity is based on the first relaxation factor.

6. The apparatus of claim 3, the at least one processor being further configured to:
receive, from the base station, a first indication indicative of whether the UE is to monitor for one or more downlink control information (DCI) with cyclic redundancy check (CRC) scrambled by power saving-radio network temporary identifier (PS-RNTI) (DCP) messages at one or more DCP monitoring occasions during the predetermined time period; and
monitor for the one or more DCP messages or refrain from monitoring for the one or more DCP messages during the predetermined time period based on the first indication.

7. The apparatus of claim 3, the at least one processor being further configured to:
receive, from the base station, an indication of a second time period threshold associated with measuring one or more radio link monitoring (RLM) reference signals or one or more beam failure detection (BFD) reference signals;
measure the one or more RLM reference signals or the one or more BFD reference signals based on an original measurement periodicity during the predetermined time period if the predetermined time period is less than the second time period threshold; and
refrain from measuring the one or more RLM reference signals or the one or more BFD reference signals during the predetermined time period if the predetermined time period is greater than the second time period threshold.

8. The apparatus of claim 3, the at least one processor being further configured to:
receive, from the base station, an indication of a second time period threshold and an indication of a second relaxation factor, the second time period threshold and the second relaxation factor being associated with measuring one or more radio link monitoring (RLM) reference signals or one or more beam failure detection (BFD) reference signals; and
measure the one or more RLM reference signals or the one or more BFD reference signals based on an original measurement periodicity or a second measurement periodicity during the predetermined time period, wherein the one or more RLM reference signals or the one or more BFD reference signals are measured based on the original measurement periodicity if the predetermined time period is less than the second time period threshold, the one or more RLM reference signals or the one or more BFD reference signals are measured based on the second measurement periodicity if the predetermined time period is greater than the second time period threshold, the second measurement periodicity is associated with a longer period than the original measurement periodicity, and the second measurement periodicity is based on the second relaxation factor.

9. The apparatus of claim 3, the at least one processor being further configured to:
receive, from the base station, an indication of a first search space switching group (SSSG) associated with a first event; and
use the first SSSG at the first event based on the indication of the first SSSG.

10. The apparatus of claim 9, wherein the first event corresponds to at least one of the UE starting a discontinuous reception (DRX) on duration, the UE activating a new bandwidth part (BWP), or the UE activating a new secondary cell (SCell).

11. The apparatus of claim 3, the at least one processor being further configured to:
use a default search space switching group (SSSG) at a first event if an indication of an SSSG is not received from the base station.

12. The apparatus of claim 3, the at least one processor being further configured to:
transmit, to the base station, one or more indications of one or more UE-requested parameters associated with adaptive PDCCH monitoring, wherein the configuration for skipping the PDCCH monitoring is based on at least one of the one or more UE-requested parameters.

13. The apparatus of claim 12, wherein the one or more indications of the one or more UE-requested parameters are transmitted to the base station via a UE assistance information (UAI) message.

14. The apparatus of claim 12, further comprising a transceiver coupled to the at least one processor, wherein the one or more UE-requested parameters associated with the adaptive PDCCH monitoring include one or more time durations associated with skipping the PDCCH monitoring or at least one time duration associated with a search space switching group (SSSG) switch timer.

15. A method of wireless communication at a user equipment (UE), comprising:
receiving, from a base station, a configuration for skipping physical downlink control channel (PDCCH) monitoring for a predetermined time period;
identifying whether a first condition is met during the predetermined time period, the first condition being associated with a first time window that overlaps at least in part with the predetermined time period; and
performing the PDCCH monitoring if the first condition is met during the predetermined time period or skipping the PDCCH monitoring if the first condition is not met during the predetermined time period, the PDCCH monitoring being skipped based on the configuration for skipping the PDCCH monitoring.

16. An apparatus for wireless communication at a base station, comprising:
a memory; and
at least one processor coupled to the memory and configured to:
select a configuration for skipping physical downlink control channel (PDCCH) monitoring for a predetermined time period; and
transmit, to a user equipment (UE), the configuration for skipping the PDCCH monitoring,
wherein the PDCCH monitoring is performed if a first condition is met during the predetermined time period or the PDCCH monitoring is skipped if the first condition is not met during the predetermined time period, the PDCCH monitoring being skipped based on the configuration for skipping the PDCCH monitoring, the first condition being associated with a first time window that overlaps at least in part with the predetermined time period.

17. The apparatus of claim 16, wherein the first condition is met if 1) a scheduling request (SR) is pending, 2) a Message 2 (Msg2) random access response (RAR) window or a Message B (MsgB) response window is not expired, 3) a contention resolution timer is not expired, or 4) an uplink hybrid automatic repeat request (HARQ) retransmission timer is not expired.

18. The apparatus of claim 16, wherein the PDCCH monitoring is skipped during a part of the predetermined time period that does not overlap with the first time window.

19. The apparatus of claim 16, the at least one processor being further configured to:
transmit, to the UE, an indication of a first time period threshold associated with a transmission of a channel state information (CSI) or a sounding reference signal (SRS); and
receive, from the UE during the predetermined time period, one or more of the CSI or the SRS based on an original periodicity if the predetermined time period is less than the first time period threshold,
wherein no CSI or SRS is received during the predetermined time period if the predetermined time period is greater than the first time period threshold.

20. The apparatus of claim 16, the at least one processor being further configured to:
transmit, to the UE, an indication of a first time period threshold and an indication of a first relaxation factor, the first time period threshold and the first relaxation factor being associated with a transmission of a channel state information (CSI) or a sounding reference signal (SRS); and
receive, from the UE during the predetermined time period, one or more of the CSI or the SRS based on an original periodicity or a second periodicity, wherein the one or more of the CSI or the SRS is received based on the original periodicity if the predetermined time period is less than the first time period threshold, the one or more of the CSI or the SRS is received based on the second periodicity if the predetermined time period is greater than the first time period threshold, the second periodicity is associated with a longer period than the original periodicity, and the second periodicity is based on the first relaxation factor.

21. The apparatus of claim 16, the at least one processor being further configured to:
transmit, to the UE, a first indication indicative of whether the UE is to monitor for one or more downlink control information (DCI) with cyclic redundancy check (CRC) scrambled by power saving-radio network temporary identifier (PS-RNTI) (DCP) messages at one or more DCP monitoring occasions during the predetermined time period.

22. The apparatus of claim 16, the at least one processor being further configured to:
transmit, to the UE, an indication of a second time period threshold associated with a measurement of one or more radio link monitoring (RLM) reference signals or one or more beam failure detection (BFD) reference signals.

23. The apparatus of claim 22, the at least one processor being further configured to:
transmit, to the UE, an indication of a second relaxation factor associated with the measurement of the one or more radio link monitoring RLM reference signals or the one or more BFD reference signals.

24. The apparatus of claim 16, the at least one processor being further configured to:
transmit, to the UE, an indication of a first search space switching group (SSSG) associated with a first event,
wherein the first SSSG is used at the first event based on the indication of the first SSSG.

25. The apparatus of claim 24, wherein the first event corresponds to at least one of starting of a discontinuous reception (DRX) on duration, activation of a new bandwidth part (BWP), or activation of a new secondary cell (SCell).

26. The apparatus of claim 16, wherein a default search space switching group (SSSG) is used at a first event if an indication of an SSSG is not transmitted to the UE.

27. The apparatus of claim 16, the at least one processor being further configured to:
receive, from the UE, one or more indications of one or more UE-requested parameters associated with adaptive PDCCH monitoring, wherein the configuration for skipping the PDCCH monitoring is selected based on at least one of the one or more UE-requested parameters.

28. The apparatus of claim 27, wherein the one or more indications of the one or more UE-requested parameters are received from the UE via a UE assistance information (UAI) message.

29. The apparatus of claim 27, further comprising a transceiver coupled to the at least one processor, wherein the one or more UE-requested parameters associated with the adaptive PDCCH monitoring include one or more time durations associated with skipping the PDCCH monitoring or at least one time duration associated with a search space switching group (SSSG) switch timer.

30. A method of wireless communication at a base station, comprising:
selecting a configuration for skipping physical downlink control channel (PDCCH) monitoring for a predetermined time period; and
transmitting, to a user equipment (UE), the configuration for skipping the PDCCH monitoring,
wherein the PDCCH monitoring is performed if a first condition is met during the predetermined time period or the PDCCH monitoring is skipped if the first condition is not met during the predetermined time period, the PDCCH monitoring being skipped based on the configuration for skipping the PDCCH monitoring, the first condition being associated with a first time window that overlaps at least in part with the predetermined time period.
